(19) United States
(12) Patent Application Publication
(10) Pub. No.: US 2002/0059864 A1
(43) Pub. Date: May 23, 2002

(54) Method for desulfurizing a gas stream

(75) Inventors: Frans Johan Joseph Gerard Janssen, Arnhem (NL); Ronald Meijer, Arnhem (NL)

Correspondence Address: Barbara E. Johnson, Webb Ziesenheim Logsdon Orkin & Hanson, 700 Koppers Building, 436 Seventh Avenue, Pittsburgh, PA, 15219, US

(73) Assignee: N.V. KEMA

(21) Appl. No.: 09/998,475

(22) Filed: Oct. 31, 2001

Related U.S. Application Data
(62) Division of application No. 09/387,909, filed on Sep. 1, 1999, now abandoned.
Application No. 09/387,909 is a continuation of application No. 09/060,624, filed on Apr. 15, 1998, now abandoned.
Application No. 09/060,624 is a continuation of application No. 08/591,427, filed on Jan. 19, 1996, now abandoned.

(30) Foreign Application Priority Data
Jan. 20, 1995 (EP) 95200143.6

(51) Int. Cl. B01J 23/85; B01D 53/12

(52) U.S. Cl. 95/108; 423/230; 423/244.06; 502/307; 502/309; 502/314; 502/315; 502/316; 502/308

(57) ABSTRACT

The invention relates to a process for removing sulfur containing compounds such as H₂S and COS from a gas stream, comprising contacting the gas stream with an absorbent in a fluidized bed, which absorbent is based on at least one oxide of a first metal selected from the group consisting of Mn, Fe, Co, Ni, Cu and Zn, in combination with at least one oxide of a second metal selected from the group consisting of Cr, Mo and W on a carrier selected from the group consisting of Al₂O₃, TiO₂, or ZrO₂ or mixtures thereof, said absorbent being in the form of particles.

The present invention relates to a method for desulfurizing a gas stream and to an absorbent suitable for this process.

The need to remove sulfur compounds, especially hydrogen sulfide, from gas streams in chemical processes is known.

In the gasification of coal or heavy oil fractions or biomass and all types of waste, hydrogen sulfide formation occurs. Due to the corrosive nature of hydrogen sulfide and to the fact that this is poisonous for catalysts which are used to convert gases into useful compounds, this hydrogen sulfide has to be removed. Furthermore if H₂S is not removed from these gases, SO₂ formation can occur which if released is environmentally dangerous. There are a great number of methods known for the removal of hydrogen sulfide from gas streams in fixed beds. The Dutch patent applications 9202282 and 9202283 both describe a method for desulfurizing of a gas in a fixed bed reactor by means of absorbents not suitable for fluidized beds.

The object of the present invention is to provide a fluidized bed process for the removal of sulfur containing compounds from a gas stream by an absorbent, which absorbent substantially does not suffer from attrition.

The present invention therefore provides a process for removing sulfur containing compounds such as H₂S and COS from a gas stream, comprising contacting a gas stream with an absorbent in a fluidized bed reactor, which absorbent is based on at least one oxide of a first metal selected from the group consisting of Mn, Fe, Co, Ni, Cu and Zn, in combination with at least one oxide of a second metal, selected from the group consisting of Cr, Mo and W on a carrier selected from a group consisting of Al₂O₃, TiO₂, or ZrO₂ or mixtures thereof, said absorbent being in the form of particles, having a particle size of 0.1- 5 mm and wherein the absorbent has a specific surface of 100-500 m²/g.

By this process, very good absorption of hydrogen sulfide is achieved together with the advantages yielded by carrying out the desulfurizing process in a fluidized bed reactor, which offers a better mixing of the gas and absorbent and therefore better contact there between than is the case with fixed bed reactors.

This absorbent also yields the advantage that attrition thereof is almost zero during the desulfurizing process in a fluidized bed reactor.

The combination of the first metal oxide and the second metal oxide on the carrier, absorbs and converts hydrogen sulfide very well with a high loading degree, whereby the metal oxides are transformed into metal sulfides.

Besides this, the absorbents are able to be regenerated to substantially their original capacity.

The particle size of the absorbent preferably lies in the range of 0.1-5 mm.

The specific surface area of the absorbent preferably lies between 100 and 500 m²/g.

The sum of the metal oxides on the carrier preferably lies between 0.01 and 50 wt.-% and most preferably between 10 and 30 wt.-%.

The absorbent, when loaded, is preferably regenerated with an oxidising gas stream in a fluidised bed reactor and then recirculated. The gas stream preferably comprises SO₂ and oxygen whereby the metal sulfide is regenerated to the metal oxide during oxidation to release sulfur vapor. This yields the advantage that the formation of corrosive sulfate is prevented.

The process is preferably carried out at a temperature range between 200 and 700° C. and at a pressure of between 0.1-5.0 MPa.

The above conditions provide for an optimum process.

According to a second aspect of the present invention, there is provided an absorbent suitable for absorbing sulfur compounds in the above mentioned fluidized bed process.

According to a third aspect of the present invention there is provided a process for preparing the above mentioned absorbent comprising the sequential impregnation of the first metal oxide and the second metal oxide on the carrier.

The impregnation of the first metal oxide is preferably a two stage treatment in order to effectively impregnate the carrier. For the preparation of the absorbent, metal nitrate, citrate or acid solutions calculated to yield a predetermined metal oxide content in the absorbent, can be used, the order of deposition being unimportant for the working of the absorbent.

The absorbent according to the present invention is classified as a D-powder, based on the particle diameter and density.

A D-powder is defined as having the following fluidisation properties:

bubbles coalesce rapidly and grow to large size;

bubbles rise more slowly than the rest of the gas percolating through the emulsion;

the dense phase has a low voidage (porosity);

when the bubble size approaches the bed diameter, flat slugs are observed;

these solid spout easily;

a large amount of gas is needed to fluidise these solids.

The invention will now be further illustrated by means of non-limiting examples.

### EXAMPLE 1

Experimental Procedure

1. Preparation of a 12 wt.-% Fe₂O₃, 12 wt. -% MoO₃ on an Al₂O₃ Absorbent

The Al₂O₃ carrier material was calcined at 1100 K and cooled down to room temperature. Iron nitrate solution, calculated to yield an Fe₂O₃ content in the absorbent of 6 wt.-%, was impregnated under vacuum on the carrier material at a pH of less than 3.5. This was then heated in air to 500° C. whereafter calcination at this temperature followed for two hours. Following this, the carrier and iron compound were cooled down to room temperature and evacuated for 30 minutes.

Impregnation under vacuum of a further iron nitrate solution, calculated to yield an Fe₂O₃ content of 12 wt.-% was then carried out at a pH of less than 3.5. The absorbent was then heated in air to 500° C., whereafter calcination followed at this temperature for two hours. The absorbent was then cooled to room temperature and evacuated for 30 minutes, whereafter impregnation was carried out under vacuum of 80-90% of the pore volume with ammonium heptamolybdate solution of molybdenum acid calculated to yield a MoO₃ content of 12 wt.-% in the absorbent. The absorbent was then heated in air to 500° C. whereafter calcination followed at this temperature for two hours. Finally the absorbent was cooled to room temperature.

### EXAMPLE 2

Desulfurizing of a Gas Stream in a Fluidized Bed Reactor

An absorbent was used which consisted, as above, of Fe₂O₃ and MoO₃, with an atomic Fe/Mo ratio of 1.80 carried on an Al₂O₃ carrier wherein the wt.-% of the Fe₂O₃, MoO₃ respectively were 12 on the carrier.

The absorbent has a particle size of about 1 mm and a specific surface of 140 m²/g, Brunauer Emmett Teller (BET).

Ten absorption/regeneration cycles were carried out in a fluidized bed reactor. The experimental conditions under which these tests were carried are summarized in table 1.

TABLE 1
Experimental conditions of example 2

| | | | Gas | | | | | | | | |
|---|---|---|---|---|---|---|---|---|---|---|---|
| | p | T | flow | Gas composition (volume per cent) | | | | | | | |
| | (Mpa) | (° C.) | L. min⁻¹ | O₂ | N₂ | N₂/Ar | H₂S | H₂O | CO | H₂ | CO₂ |
| Absorption | 0.4 | 350 | 85 | — | — | 2.7 | 0.075/ | 5 | 60 | 30 | 2 |
| | | | | | | | 0.3 | | | | |
| Regenera- | 0.4 | 600 | 85 | 1 | 99 | — | — | — | — | — | — |
| tion | | | | | | | | | | | |

COS was present at the entry to the absorbent bed, due to the thermodynamic equilibrium of the reaction CO+H₂S≈→COS and H₂.

The absorbent was introduced into the reaction bed whereafter the reactor was raised to a temperature of 350° C. Thereafter an H₂S containing gas stream was introduced into the reactor. The sulfur components H₂S and COS reacted with the absorbent to produce metal sulfides. Maximum absorption was indicated when the sulfur containing components passed unhindered through the reactor.

After absorption, regeneration of the absorbent took place. An oxygen containing gas mixture was guided over the absorbent whereby the metal sulfides reacted with the oxygen and SO₂ to produce SO₂ and sulfur vapor and the absorbent was regenerated.

The absorption bed and regeneration bed were aligned in series.

Results of Example 2

Absorption

During the absorption of H₂S, Fe₂O₃ and MoO₃ were transformed into FeS and MoS₂ respectively.

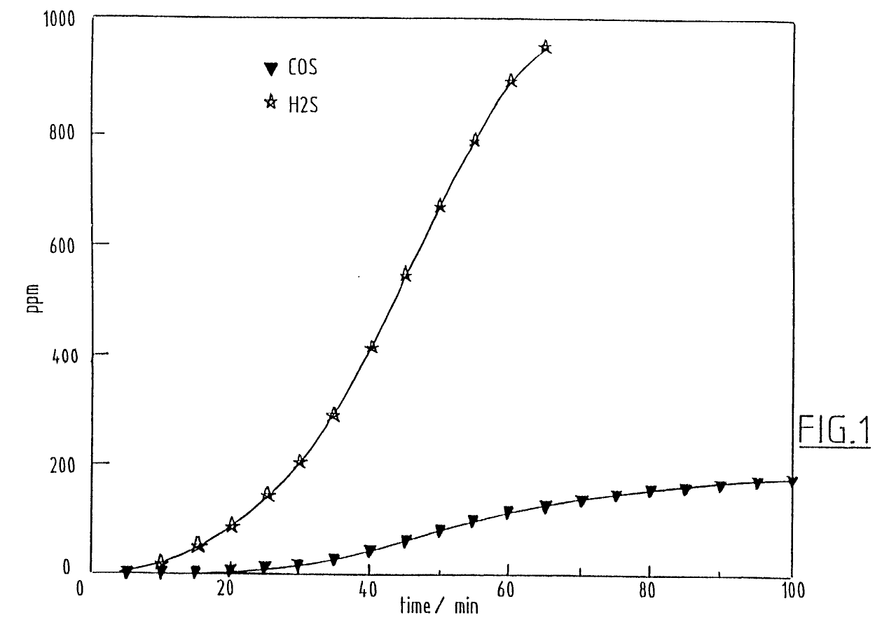

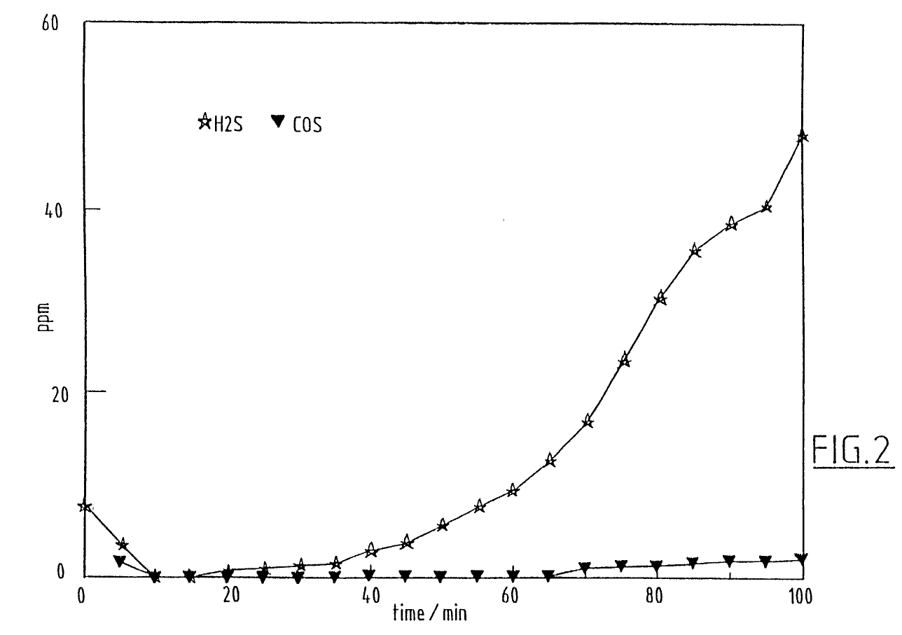

FIGS. 1 and 2 show the H₂S and COS breakthrough curves, which were measured during absorption with an H₂S entry concentration of 3000 and 750 ppm, respectively.

During the absorption/regeneration cycles, a little spreading of the H₂S and COS break through curves was observed. No significant deactivation of the absorbent was observed.

The removal of 3000 ppm H₂S during a time period of 40 minutes, corresponded with a sulfur loading on the absorbent of 4 wt.-% sulfur.

A degree of sulfur removal greater than 99.0% at 750 ppm H₂S was realized. This corresponds to a sulfur uptake capacity of ±5 wt.-% sulfur.

Regeneration

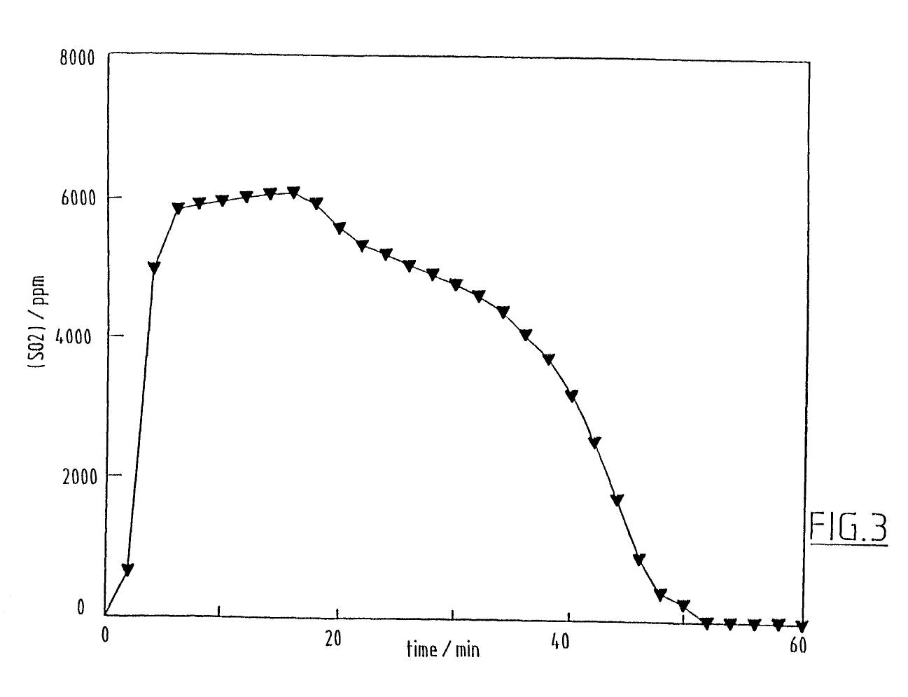

FIG. 3 shows the SO₂ formation as a function of time for regeneration with 1 volume per cent O₂ in N₂. Characteristic for the SO₂ production profile is an initial SO₂ concentration of ±6000 ppm, which dropped to a value of 5000 ppm or less after about 20 minutes.

Due to the regeneration of FeS and MoS₂ to Fe₂O₃ and MoO₃ respectively, an SO₂ concentration of ±5700 ppm is expected with complete conversion of O₂.

The drop in the curve of FIG. 3, can be explained due to the sulfur formation during the oxygen regeneration. During the experiments it appeared that a significant amount of elementary sulfur is formed.

The process and absorbent according to the present invention showed no deactivation and regeneration of the absorbent in O₂ at 600° C. was complete whereby SO₂ and sulfur vapor were produced. No measurable attrition of the absorbent was observed during the ten completed absorption/regeneration cycles.

### EXAMPLE 3

Long Term Performance of the Absorbent

An absorbent was used which consisted of 10 wt.-% Fe₂O₃ and 10 wt.-% MoO₃, with an atomic ratio of 1.80 supported by Al₂O₃. The absorbent had a particle size of about 1 mm and a specific surface of 140 m²/g (BET).

56 absorption, regeneration cycles were carried out in a single stage fluidised bed reactor. The experimental conditions are summarized in Table 2.

TABLE 2
Experimental conditions example 3

| | p | T | Gasflow | Gas composition (volume per cent) | | | | | | | |
|---|---|---|---|---|---|---|---|---|---|---|---|
| | (Mpa) | (° C.) | L. min⁻¹ | SO₂ | O₂ | H₂S | H₂O | CO | H₂ | CO₂ | N₂ |
| Absorption | 2.0 | 350-450 | 200-230 | — | — | 0.025-0.3 | 2-10 | 60 | 30 | 2 | balance |
| Regeneration | 2.0 | 600-650 | 150-160 | 0-50 | 0-2 | — | — | — | — | — | balance |

COS was present at the entry of the absorbent bed, due to the thermodynamic equilibrium of the reaction CO+H₂S COS=H₂.

The absorbent was introduced into the reaction bed whereafter the temperature of the reactor was raised to the absorption temperature. Thereafter the H₂S containing gas stream was introduced into the reactor. The sulphur components H₂S and COS reacted with the absorbent to produce metal sulfides. Maximum absorption was indicated when breakthrough of H₂S and COS was observed.

Regeneration was performed in a gas mixture containing SO₂/O₂ with a balance of N₂. The metal sulfides react with oxygen and SO₂ to produce metal oxides and sulphur vapor.

Results of Example 3

H₂S Absorption

During the 56 cycle programme the absorbent was kept fluidised for 850 hours of which 25% under absorption or regeneration conditions. For the remaining time the absorbent was fluidised in N₂ at 350° C. and 0.2 MPa.

During absorption of H₂S, Fe₂O₃ and MoO₃ were transformed into FeS and MoS₂ respectively.

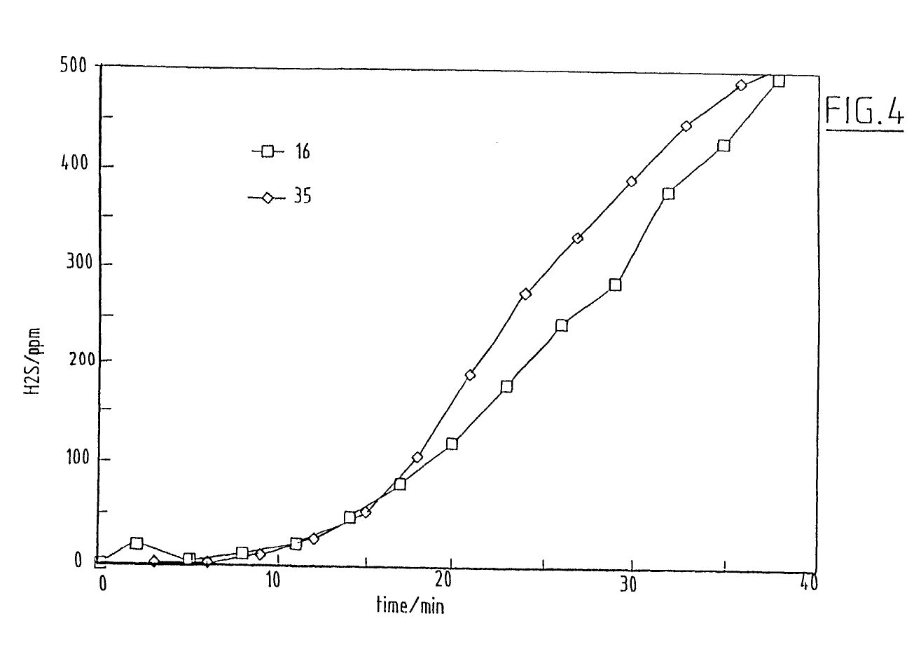

FIG. 4 shows the outlet concentration of H₂S as a function of time. The sulfur uptake capacity remained constant under the conditions mentioned in Table 2. No significant deactivation of the absorbent was observed.

The total sulfur uptake capacity of the absorbent after 56 cycles in the fluid bed reactor is similar to that of the fresh absorbent and amounts to 6.0 wt.-% S.

SO₂/O₂ Regeneration

During regeneration in a SO₂/O₂ mixture the metal sulfides are converted into metal oxides and sulphur vapor. Sulphur is the only product formed.

Attrition from Experiment 3

The attrition of the absorbent during the test programme was obtained by monitoring the amount of absorbent that elutriated from the reactor and the particle size distribution of the absorbent in the reactor. Table 3 shows the cumulative elutriation as a function of the cycle number and total time of fluidisation.

From this table it was calculated, see below, that the overall rate of elutriation from the reactor amounted to approximately 0.3 wt.-%/day. Separately the attrition was measured in a ‘three hole’ attrition test system. The rate of elutriation for a fresh absorbent and the spent absorbent after 56 cycles in the fluid bed reactor, amounted to 0.12 and 0.15 wt.-%/day respectively.

TABLE 3
Total time of fluidisation and cumulative
elutriation

| | Total time of fluidisation | Cumulative elurtriation |
|---|---|---|
| Cycle number | (hours) | (wt.-% of reactor content) |
| 15 | 140 | 0.63 |
| 25 | 360 | 2.42 |
| 35 | 600 | 5.25 |
| 43 | 650 | 6.38 |
| 56 | 850 | 10.22 |

The cumulative elutriation was calculated by dividing the weight loss from the reactor by the initial weight of sorbent loaded in the reactor.

The particle size of the elutriated fines was smaller than 170 μm.

The particle size distribution of the reactor inventory after 850 hours is as follows:

| Particle size mm | % |
|---|---|
| dₚ > 0.8 | 80 |
| 0.5 < dₚ < 0.8 | 16 |
| dₚ < 0.5 | 4 |

Following these results it is concluded that the absorbent according to the present invention is suitable for use in a fluid bed reactor.

1. Process for removing sulfur containing compounds such as H₂S and COS from a gas stream, comprising contacting the gas stream with an absorbent in a fluidized bed, which absorbent is based on at least one oxide of a first metal selected from the group consisting of Mn, Fe, Co, Ni, Cu and Zn, in combination with at least one oxide of a second metal selected from the group consisting of Cr, Mo and W on a carrier selected from the group consisting of Al₂O₃, TiO₂, or ZrO₂ or mixtures thereof, said absorbent being in the form of particles, having a particle size of 0.1-5 mm and wherein the absorbent has a specific surface of 100-500 m²/g.

2. Process according to the claim 1, wherein the sum of the metal oxides on the carrier is between 0.01 and 50 wt.-%.

3. Process according to claim 2, wherein the sum of the metal oxides on the carrier is between 10 and 30 wt.-%.

4. Process according to any of the preceding claims, wherein the loaded absorbent is regenerated with an oxidising gas stream and recirculated.

5. Process according to claim 4, wherein the gas stream comprises oxygen or a mixture of oxygen and sulfur dioxide.

6. Process according to claim 5, wherein sulfur is produced.

7. Process according to any of the preceding claims, carried out at a temperature range of between 200-700° C.

8. Process according to any of the preceding claims, carried out at a pressure of between 0.1-5 Mpa.

9. Absorbent suitable for absorbing sulfur compounds in a fluidized bed process according to the claims 1-8 comprising at least one oxide of a first metal selected from the group consisting of Mn, Fe, Co, Ni, Cu and Zn in combination with at least one oxide of a second metal selected from the group consisting of Cr, Mo and W on a carrier selected from the group consisting of Al₂O₃, TiO₂, or ZrO₂ or mixtures thereof, said absorbent being in the form of particles, having a particle size of 0.1-5 mm and wherein the absorbent has a specific surface of 100-500 m²/g.

10. Absorbent according to claim 9, wherein the sum of the metal oxides on the carrier is between 0.01 and 50 wt.-%.

11. Absorbent according to claim 9, wherein the sum of the metal oxides on the carrier is between 10 and 30 wt.-%.

12. Process for preparing an absorbent as claimed in claims 9-11 suitable for use in a process according to the claims 1-8, comprising sequential impregnation of the first metal oxide and the second metal oxide on the carrier.

13. Process according to claim 12, wherein the impregnation of the first metal oxide is a two stage treatment.

14. Process according to claim 13, comprising the steps of calcining the carrier, impregnation under vacuum of said carrier material with a nitrate, citrate or acid solution of the first metal, calculated to yield a predetermined metal oxide content in the absorbent, at a pH of roughly less than 3,5 whereafter this step is repeated to be followed by impregnation under vacuum with a nitrate, citrate or acid solution of the second metal precalculated to yield a predetermined weight per cent in the absorbent.

15. Absorbent suitable for absorbing sulfur containing compounds such as H₂S and COS from a gas stream produced by sequentially impregnating a carrier with at least one oxide of a first metal selected from the group consisting of Mn, Fe, Co, Ni, Cu and Zn and at least one oxide of a second metal selected from the group consisting of Cr, Mo, and W wherein the carrier is selected from the group consisting of Al₂O₃, TiO₃ or ZrO₂ or mixtures thereof and wherein the absorbent is in the form of particles, having a particle size of 0.1-5 mm and wherein the absorbent has a specific surface of 100-500 m²/g.

16. Absorbent produced according to claim 15, wherein the impregnation of the first metal oxide is a one or two stage treatment.
